(19) United States
(12) Patent Application Publication
(10) Pub. No.: US 2006/0047815 A1
(43) Pub. Date: Mar. 2, 2006

(54) Adapting computer resource usage based on forecasted resource availability

(75) Inventor: Youssef Hamadi, Cambridge (GB)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/931,818

(22) Filed: Sep. 1, 2004

(51) Int. Cl. G06F 15/173

(52) U.S. Cl. 709/226

(57) ABSTRACT

An exemplary method includes forecasting availability of a system resource, adapting a policy for handling requests for the system resource based on the forecasted availability, and handling a request for the system resource according to the policy. An exemplary system includes a forecasting module forecasting availability of one or more resources required to handle a request and a policy management module adapting a policy of using the one or more resources when the request is received based on the forecasted availability.

### TECHNICAL FIELD

The described subject matter relates to computing systems. More particularly, the subject matter relates to adaptability of resource usage in computing systems through resource forecasting.

### BACKGROUND

Programs that execute on computers use resources to perform tasks. Such resources provide data to, or perform functions for, the programs and can be internal or external to the computer. For various reasons, these resources may or may not be available at any given time, or may be available at a particular level. For example, a typical computer uses a computer network resource to communicate with other computers. The computer network may fail, or bandwidth over the computer network may be significantly reduced due to a burst of communications traffic over the network. Thus, the availability of resources varies with time. Unfortunately, traditional systems do not effectively handle the variation in resource availability over time.

A common approach to system development is to simply assume that a resource will be available when the resource is required. Of course, this is not always the case. When a system attempts to access a resource that is not available, or available only at a minimal level, system performance can be greatly hindered. For example, a computer that requests a resource that is unavailable may be put in a first-in-first-out (FIFO) queue and be forced to wait until the resource becomes available, causing significant delays.

### SUMMARY

Implementations of systems and methods provide for adaptability of resource usage through resource forecasting. An exemplary method includes forecasting availability of a system resource, adapting a policy for handling requests for the system resource based on the forecasted availability, and handling a request for the system resource according to the policy. An exemplary system includes a forecasting module forecasting availability of one or more resources required to handle a request and a policy management module adapting a policy of using the one or more resources when the request is received based on the forecasted availability.

### BRIEF DESCRIPTION OF THE DRAWINGS

FIG. 1 is a block diagram of an exemplary system interacting with an application to adapt a resource usage policy based on forecasted resource availability;

FIG. 2 illustrates a vehicle-based scenario in which the exemplary system of FIG. 1 can be utilized;

FIG. 3 is a block diagram of an exemplary forecast module forecasting resource availability and an exemplary policy module revising resource usage policies based on forecasted resource availability;

FIG. 4 illustrates a flowchart having exemplary operations for adapting resource usage based on forecasted resource availability;

FIG. 5 illustrates a suitable computing environment in which adaptability through resource forecasting may be implemented.

### DETAILED DESCRIPTION

Exemplary System

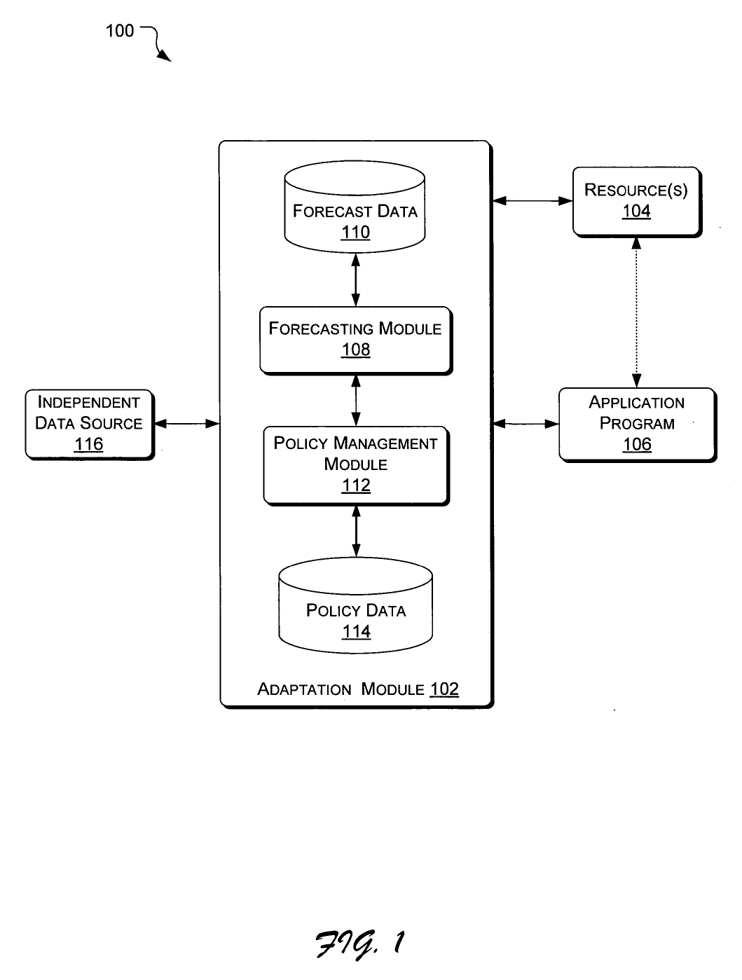

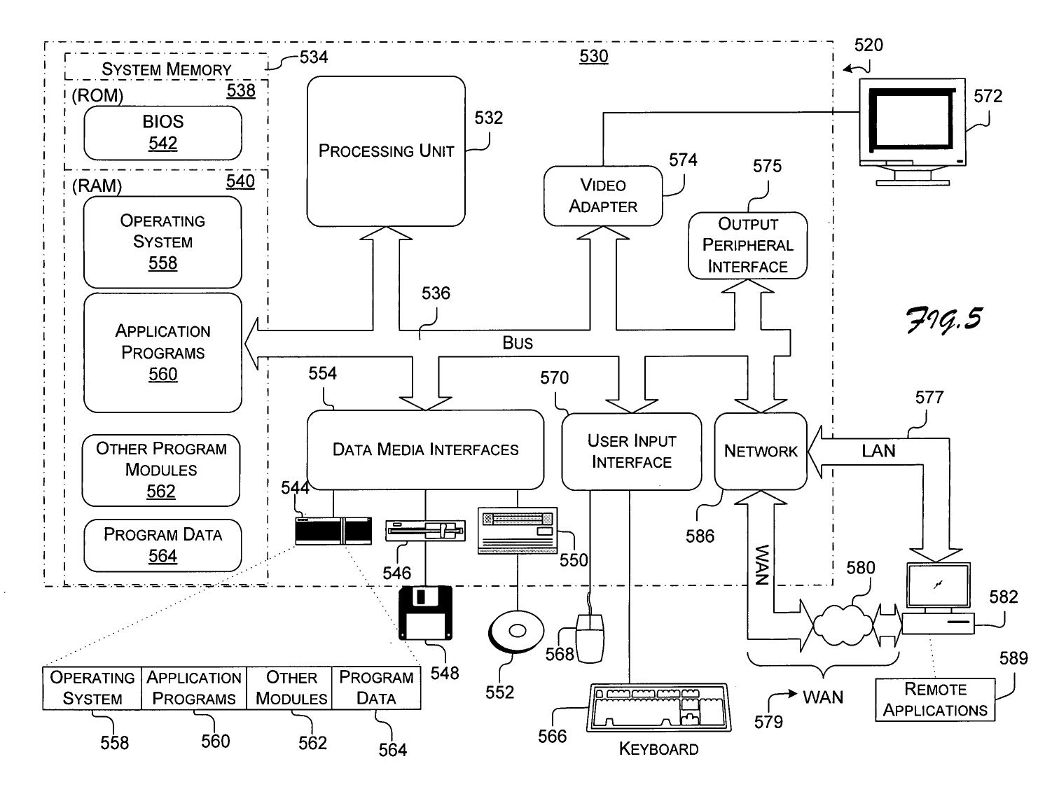

FIG. 1 shows an exemplary system 100 including an adaptation module 102 to adapt usage of one or more system resource(s) 104 by an application program 106 based on forecasted availability of the resource(s) 104. The system 100 can be implemented in a computing environment, such as the general purpose computing environment shown in FIG. 5. A resource 104 is a finite quantity of computing component in the system 100 that is utilized to perform tasks or functions requested by the application program 106. Examples of resource(s) 104 include hardware devices, ports, CPU processing, memory, USB bandwidth, network bandwidth, software modules, and so forth.

The resource(s) 104 may not be immediately available for use when requested by the application program 106, or the resource(s) 104 may be available only on a limited basis. For example, a video memory resource may be in use by another application program and not usable by the application program 106. As another example, a communication network resource may provide only very limited bandwidth at certain times. It is assumed that the availability of resource(s) 104 can be forecasted to some extent.

An adaptation module 102 includes a forecasting module 108 for forecasting the availability of resource(s) 104. The forecasting module 108 forecasts the availability of resource(s) 104 based on request(s) received from the application program 106. The request(s) received from the application program 106 specify one or more of the resource(s) 104 or a function that requires one or more of the resource(s) 104. For example, a hypertext transfer protocol (HTTP) request will specify a particular webpage on the Internet. As another example, a request for a function will specify the function name.

The forecasting module 108 uses forecast data 110 related to the requested resource(s) 104 to determine when the requested resource(s) 104 are available for use. Forecast data 110 generally includes data that associates availability of the requested resource(s) 104 with an independent variable, such as time or location. The availability may be specified as a level (e.g., 128 kbytes of bandwidth) within a continuum of availability, or as a binary indicator (e.g., available/unavailable). Using the forecast data 110, the forecasting module 108 determines availability of the requested resource(s) at one or more times and sends availability information to a policy management module 112.

The policy management module 112 uses the availability information to select a resource-related policy that specifies a manner of using the resource(s) 104. The resource-related policy may dictate when the requested resource(s) 104 should be used or not used. Alternatively, the resource-related policy may dictate substitute resource(s) to use instead of the requested resource(s) 104. For example, if the forecasting module 108 indicates that a requested network will be unavailable in one minute, the policy management module 112 may switch to a policy that specifies another network to be used. Alternatively, the policy management module 112 may select a policy for downloading information in advance on the requested network, before the requested network becomes unavailable.

The policy management module 112 may use policy data 114 for managing resource-related policies. The policy data 114 includes one or more policies describing usage of the resource(s) 104. In one implementation, the policy management module 112 selects among the policies for a requested resource based on the forecasted availability of the requested resource.

An independent data source 116 may provide data that is independent of the requested resource for determining availability of the requested resource. Examples of independent data sources 116 include a system clock providing the current time or a global positioning system (GPS) providing current location. In addition, the independent data source 116 could provide data about availability of another resource that impacts the availability of the requested resource(s) 104.

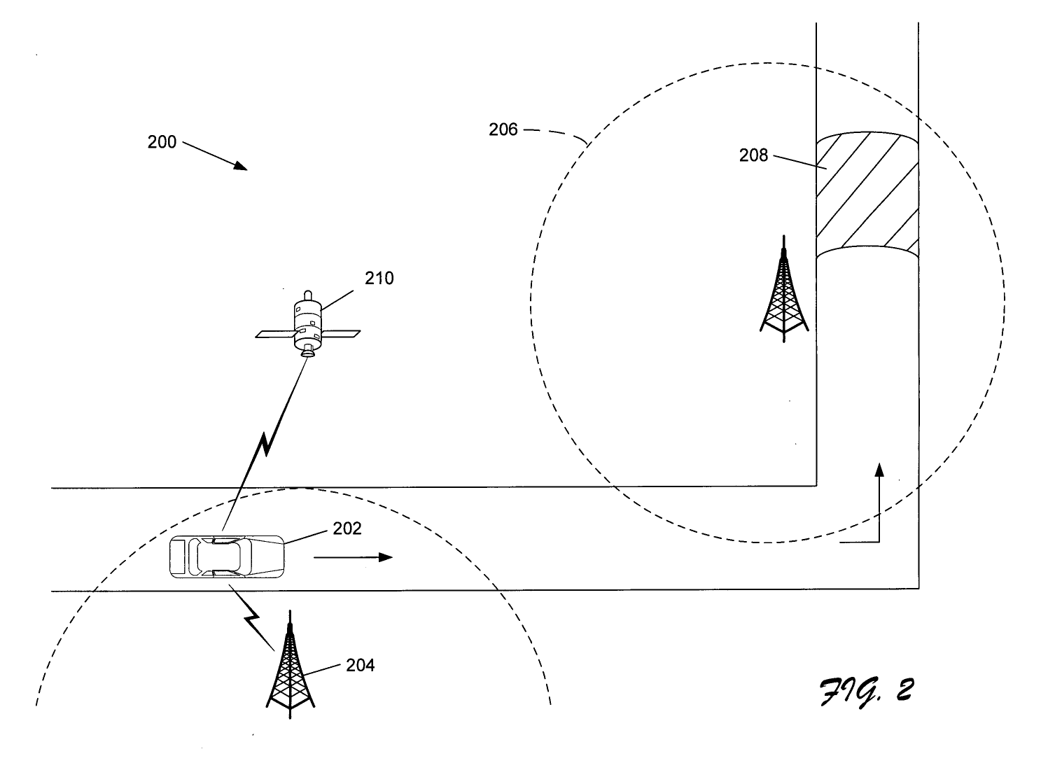

To illustrate how the adaptation module 102 can be used, an exemplary vehicle-based scenario 200 is illustrated in FIG. 2. The scenario 200 involves a computer (e.g., laptop, handheld, etc.) (not shown) operating in a moving vehicle 202. The computer in the vehicle 202 includes an adaptation module, an application program, and an independent data source. In this scenario 200, the application program is an Internet browser and the independent data source is a navigation system, such as a global positioning system (GPS). A passenger in the vehicle 202 is accessing the Internet via the Internet browser.

In the scenario, the computer accesses the Internet via a wireless connection through a cell tower 204 provided by a wireless service provider. As the passenger browses the Internet, the computer consumes resources, including network bandwidth. Thus, in this scenario, the Internet browser generates requests for Internet pages, and bandwidth is required to download the requested pages. As the vehicle 202 travels, the available bandwidth typically varies based on communication coverage. For example, the vehicle 202 may travel in and out of communication cells 206, or the vehicle 202 may travel through a tunnel 208 in which communication is temporarily lost.

In the scenario 200 of FIG. 2, the forecasting module can determine the availability of the network bandwidth based on the route that the vehicle 202 is traveling. The vehicle's 202 route could be obtained in several ways. For example, the vehicle navigation system can provide the future route of the vehicle. As another example, if the route is frequently traveled, the route may be stored in memory; in this case, the forecasting module can retrieve the route from memory.

Using the forecasting data, the forecasting module determines communication coverage at points along the route. The forecasting data includes a mapping of route locations to bandwidth availability. The forecasting data can be generated in a number of ways. For example, a wireless provider's coverage map could be used to obtain bandwidth availability, which can be stored along with the associated route points in the forecasting data.

The forecasting data can also be generated through a learning process. In this implementation, it is assumed that the vehicle 202 travels the route multiple times. Over time, as the vehicle 202 travels the route, the bandwidth at various points along the route is measured and stored. A running average of the available bandwidth can be computed at selected points along the route.

The forecasted network bandwidth is used by the policy management module to improve Internet browsing. For example, if the vehicle 202 will be entering the tunnel 208 and bandwidth will decrease, the policy management module can select from multiple bandwidth-usage policies. According to a first exemplary policy the passenger is notified that bandwidth will decrease. According to a second exemplary policy, the computer pre-fetches certain Internet information before bandwidth becomes unavailable. For example, the uniform resource locators (URLs) referenced by the current webpage may be pre-fetched. According to a third exemplary policy, the computer switches to a different type of network (e.g., switches from cellular network to a satellite network 210).

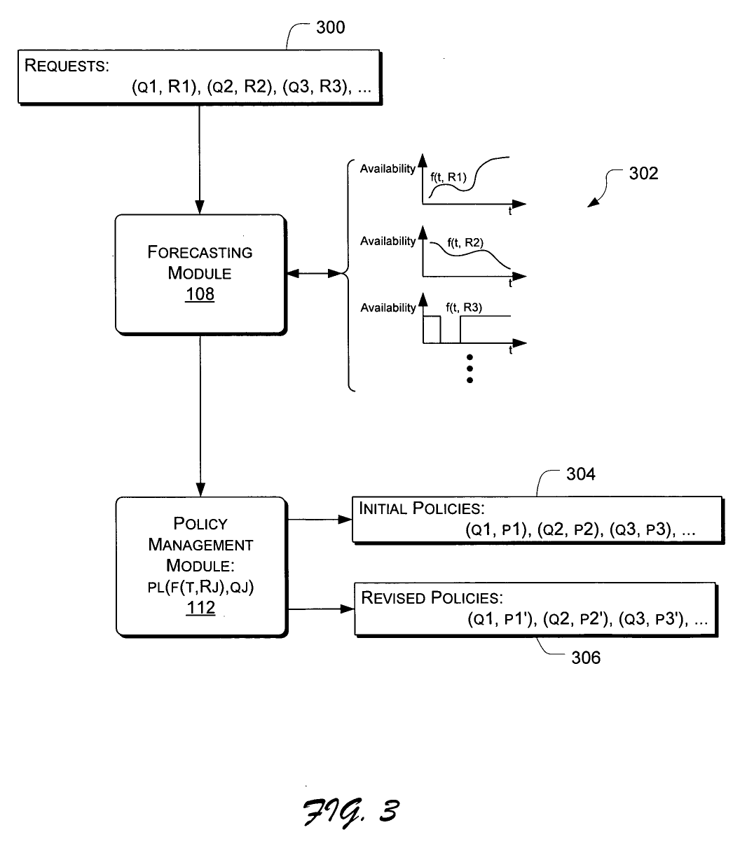

FIG. 3 is a block diagram of particular implementations of the forecasting module 108 and the policy management module 112. The forecasting module 108 receives one or more requests 300 (Q1, Q2, Q3, etc.) to perform requested operations. Each of the requests are associated with a set of one or more resources R1, R2, R3, etc., respectively. Each set of resources, Ri, can be specified by Ri={rᵢ₁, rᵢ₂, rᵢ₃, . . . }, where rᵢⱼ represents a required resource to perform request Qi.

The forecasting module 108 contains and/or uses forecasting data 302 that characterizes the availability of the resources. In one implementation, the forecasting data 302 includes functions of resource availability over time. As shown, for example, the availability of Ri is given by the function f(t, R1), the availability of R2 is given by function f(t, R2), the availability of R3 is given by function f(t, R3), and so on. The functions may be implemented in data structures (e.g., tables) that map resource availability to time, t. Alternatively, the functions may be implemented as real-time executable functions.

The policy management module 112 receives the forecasted resource availability from the forecasting module 108 and adapts a policy related to the resource. In this particular implementation, the policy management module 112 applies a policy revision function, p1(f(t, Rj), Qi). The policy revision function is a function of the forecasted availability, f(t, Rj) and the request, Qj.

As shown, initial policies 304 include request/policy pairs (Q1, P1), (Q2, P2), (Q3, P3), etc. The policy management module 112 generates a set of revised policies 306, shown as (Q1, P1′), (Q2, P2′), (Q3, P3′), etc. For example, based on the forecasted availability of resource R2, the policy management module 112 may choose revised policy P2′ for handling request Q2.

Exemplary Operations

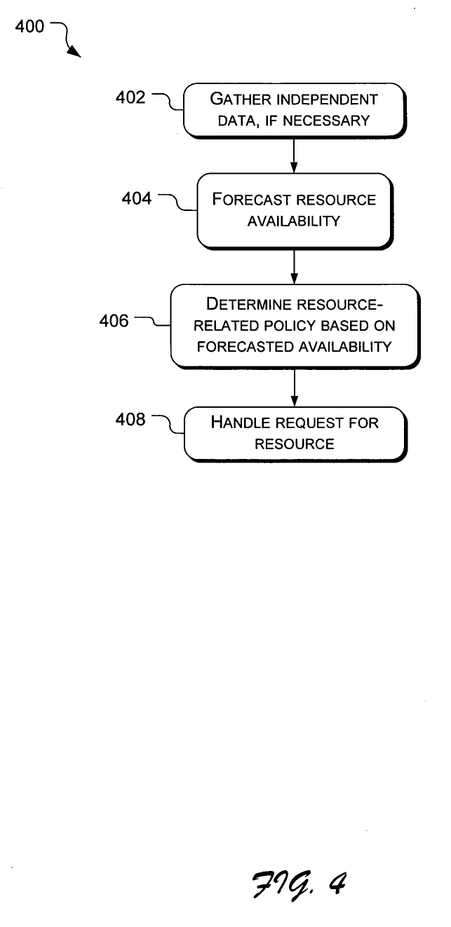

FIG. 4 depicts an adaptation algorithm 400 having exemplary operations for adapting resource usage based on forecasted resource availability. The adaptation algorithm 400 can be executed on a computer to facilitate handling of requests from an application program. The algorithm 400 may be incorporated in the application program itself, incorporated in the computer operating system, or the algorithm 400 may be a separate, stand-alone program.

An optional gathering operation 402 gathers independent data about current conditions that are relevant to availability of a resource that may be required to handle a request. The independent data is deterministic of the availability of the resource. Examples of independent data include time, location, or availability of another resource that affects the availability of the resource that may be required.

A forecasting operation 404 forecasts the availability of the resource. The forecasting operation 404 can use the independent data to forecast availability of the resource. One implementation of the forecasting operation 404 uses a function of availability of the requested resource over time to determine whether the resource is available or unavailable at selected times. Another implementation of the forecasting operation 404 uses a look-up table to look up availability of the requested resource.

A determining operation 406 determines a resource-related policy based on the forecasted availability. One implementation of the determining operation 406 selects a policy from a set of policies associated with the resource based on the forecasted availability. For example, if the resource will be unavailable soon, the determining operation 406 may select a policy that uses a substitute resource instead of the requested resource. If the resource is a communication network, the determining operation 406 may select a policy in which additional webpages are pre-fetched from the Internet if the network is forecasted to become unavailable.

A handling operation 408 handles requests for the resource using the determined policy. Exemplary requests include a request for a network connection, an Internet page, a file on a local drive, or access to a memory location. The handling operation 408 associates the request with a resource that is required to satisfy the request. For example, a request for an Internet page requires a network connection with sufficient bandwidth. A request to save a file requires memory on a disk drive.

The forecasting operation 404 and the determining operation 406 can be repeated, as necessary. These operations may be repeated periodically automatically, or in response to certain events. As an example, these operations may be executed whenever a new forecast is generated. As another example, these operations may be executed whenever a request is received.

Exemplary Computer System

FIG. 5 and the corresponding discussion are intended to provide a general description of a suitable computing environment in which the described arrangements and procedures for adapting resource usage based on forecasted resource availability. Exemplary computing environment 520 is only one example of a suitable computing environment and is not intended to suggest any limitation as to the scope of use or functionality of the described subject matter. Neither should the computing environment 520 be interpreted as having any dependency or requirement relating to any one or combination of components illustrated in the exemplary computing environment 520.

The exemplary arrangements and procedures to transport computer data between interconnected devices are operational with numerous other general purpose or special purpose computing system environments or configurations. Examples of well known computing systems, environments, and/or configurations that may be suitable for use with the described subject matter include, but are not limited to, personal computers, server computers, thin clients, thick clients, hand-held or laptop devices, multiprocessor systems, microprocessor-based systems, distributed computing environments such as server farms and corporate intranets, and the like, that include any of the above systems or devices.

The computing environment 520 includes a general-purpose computing device in the form of a computer 530. The computer 530 may include and/or serve as an exemplary implementation of an adaptation system described above with reference to FIGS. 1-4. The components of the computer 530 may include, by are not limited to, one or more processors or processing units 532, a system memory 534, and a bus 536 that couples various system components including the system memory 534 to the processor 532.

The bus 536 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

The computer 530 typically includes a variety of computer readable media. Such media may be any available media that is accessible by the computer 530, and it includes both volatile and non-volatile media, removable and non-removable media.

The system memory includes computer readable media in the form of volatile memory, such as random access memory (RAM) 540, and/or non-volatile memory, such as read only memory (ROM) 538. A basic input/output system (BIOS) 542, containing the basic routines that help to communicate information between elements within the computer 530, such as during start-up, is stored in ROM 538. The RAM 540 typically contains data and/or program modules that are immediately accessible to and/or presently be operated on by the processor 532.

The computer 530 may further include other removable/non-removable, volatile/non-volatile computer storage media. By way of example only, FIG. 5 illustrates a hard disk drive 544 for reading from and writing to a non-removable, non-volatile magnetic media (not shown and typically called a “hard drive”), a magnetic disk drive 546 for reading from and writing to a removable, non-volatile magnetic disk 548 (e.g., a “floppy disk”), and an optical disk drive 550 for reading from or writing to a removable, non-volatile optical disk 552 such as a CD-ROM, DVD-ROM or other optical media. The hard disk drive 544, magnetic disk drive 546, and optical disk drive 550 are each connected to bus 536 by one or more interfaces 554.

The drives and their associated computer-readable media provide nonvolatile storage of computer readable instructions, data structures, program modules, and other data for the computer 530. Although the exemplary environment described herein employs a hard disk, a removable magnetic disk 548 and a removable optical disk 552, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk, magnetic disk 548, optical disk 552, ROM 538, or RAM 540, including, by way of example, and not limitation, an operating system 558, one or more application programs 560, other program modules 562, and program data 564.

A user may enter commands and information into the computer 530 through optional input devices such as a keyboard 566 and a pointing device 568 (such as a “mouse”). Other input devices (not shown) may include a microphone, joystick, game pad, satellite dish, serial port, scanner, or the like. These and other input devices are connected to the processing unit 532 through a user input interface 570 that is coupled to the bus 536, but may be connected by other interface and bus structures, such as a parallel port, game port, or a universal serial bus (USB).

An optional monitor 572 or other type of display device is connected to the bus 536 via an interface, such as a video adapter 574. In addition to the monitor, personal computers typically include other peripheral output devices (not shown), such as speakers and printers, which may be connected through output peripheral interface 575.

The computer 530 may operate in a networked environment using logical connections to one or more remote computers, such as a remote computer 582. The remote computer 582 may include many or all of the elements and features described herein relative to the computer 530. The logical connections shown in FIG. 5 are a local area network (LAN) 577 and a general wide area network (WAN) 579. In a network-based computing device, the LAN 577 and/or WAN 579 may be composed of wired networks, wireless networks, or any combination of wired or wireless networks. Such networking environments are commonplace in offices, enterprise-wide computer networks, intranets, and the Internet.

When used in a LAN networking environment, the computer 530 is connected to the LAN 577 via a network interface or an adapter 586. The network interface 586 provides communications services for transmitting and receiving data to and from one or more clients. For example, the network interface 586 formats, encodes, modulates, demodulates, and decrypts data communicated via the LAN 577. The network interface 586 operably communicates over a network using a standard network communication protocol. Examples of communications devices suitable for the network interface 586 include a cellular modem, Wireless Fidelity (WiFi), or other wireless communications devices.

The network adapter 586 may also be used to facilitate communications in a WAN 579 networking environment. As such, the computer 530 typically communicates via the network adapter 586 or other means for establishing communications over the WAN 579. The network adapter 586, which may be internal or external, may be connected to the system bus 536 via the user input interface 570 or other appropriate mechanism. Depicted in FIG. 5 is a specific implementation of a WAN via the Internet.

In a networked environment, program modules depicted relative to the personal computer 530, or portions thereof, may be stored in a remote memory storage device. By way of example, and not limitation, FIG. 5 illustrates remote application programs 589 as residing on a memory device of remote computer 582. It will be appreciated that the network connections shown and described are exemplary and other means of establishing a communications link between the computers may be used.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer-readable media. Computer-readable media can be any available media that can be accessed by a computer. By way of example, and not limitation, computer-readable media may comprise “computer storage media” and “communications media.”

“Computer storage media” includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer-readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer-readable media.

Although the exemplary operating embodiment is described in terms of operational flows in a conventional computer, one skilled in the art will realize that the present invention can be embodied in any platform or environment that processes and/or communicates video signals. Examples include both programmable and non-programmable devices such as hardware having a dedicated purpose such as video conferencing, firmware, semiconductor devices, hand-held computers, palm-sized computers, cellular telephones, and the like.

Although some exemplary methods and systems have been illustrated in the accompanying drawings and described in the foregoing Detailed Description, it will be understood that the methods and systems shown and described are not limited to the particular implementation described herein, but rather are capable of numerous rearrangements, modifications and substitutions without departing from the spirit set forth herein.

What is claimed is:

1. A method comprising:
forecasting availability of a system resource;
adapting a policy for handling requests for the system resource based on the forecasted availability; and
handling a request for the system resource according to the policy.

2. A method as recited in claim 1 wherein the adapting comprises selecting a revised policy based on the forecasted availability.

3. A method as recited in claim 1 wherein the request comprises a request for an Internet page and the handling comprises pre-fetching one or more Internet pages referenced by the Internet page.

4. A method as recited in claim 1 wherein the forecasting comprises mapping independent data to the resource availability.

5. A method as recited in claim 1 wherein the forecasting operation comprises executing a real-time function relating independent data to the resource availability.

6. A method as recited in claim 1 wherein the adapting operation comprises notifying a user of the resource availability.

7. A method as recited in claim 1 further comprising gathering independent data that is deterministic of the resource availability.

8. A method as recited in claim 1 further comprising repeating the forecasting and the adapting periodically.

9. A method as recited in claim 1 further comprising repeating the forecasting and the adapting when a forecasting function is updated.

10. A method as recited in claim 1 wherein the forecasting includes applying a function of one or more of time, location, and availability of another resource that affects the resource availability.

11. A computer-readable medium having stored thereon computer-executable instructions for causing a computer to perform a process comprising:
forecasting availability of a set of one or more requested resources; and
adapting usage of the one or more requested resources based on the forecasted availability.

12. A computer-readable medium as recited in claim 11, the process further comprising:
receiving a request to perform a function; and
identifying the set of one or more resources required to perform the requested function.

13. A computer-readable medium as recited in claim 11 wherein the adapting comprises:
initially using a default usage policy to handle an initial request; and
subsequently using a revised usage policy to handle a subsequent request.

14. A computer-readable medium as recited in claim 11 wherein the forecasting comprises determining availability of each of the one or more requested resources at selected times.

15. A computer-readable medium as recited in claim 11 wherein the forecasting comprises applying a function that relates time to availability of the requested resource.

16. A computer-readable medium as recited in claim 1 1, the process further comprising generating a notification of the availability of the one or more requested resources.

17. A computer-readable medium as recited in claim 11, wherein the one or more requested resources includes network bandwidth and the adapting comprises pre-fetching network data referenced by a currently accessed network document.

18. A computer-readable medium as recited in claim 11 wherein the adapting comprises determining a resource-usage policy dictating a manner of using the one or more requested resources.

19. A computer-readable medium as recited in claim 11, the process further comprising periodically repeating the forecasting and the adapting.

20. A computer-readable medium as recited in claim 11, the process further comprising:
receiving a request to perform a function requiring the set of one or more requested resources; and
repeating the forecasting and adapting in response to receiving the request.

21. A system comprising:
a forecasting module forecasting availability of one or more resources required to handle a request; and
a policy management module adapting a policy of using the one or more resources when the request is received based on the forecasted availability.

22. A system as recited in claim 21 further comprising an independent data source generating independent data that is deterministic of the availability.

23. A system as recited in claim 21 further comprising an application program generating the request.

24. A system as recited in claim 23 wherein the application program is an Internet browser.

25. A system as recited in claim 21 further comprising:
an independent data source providing data to the forecasting module, the data being deterministic of the availability of the one or more resources; and
an application program generating the request.

26. A system as recited in claim 25 wherein the independent data source comprises a navigation system generating route information.

27. A system as recited in claim 26 wherein the application program comprises an Internet browser application generating a request for an Internet page, and the set of one or more resources includes network bandwidth, wherein the forecasting module maps the route information to availability of the network bandwidth.

28. A system as recited in claim 21 wherein one or more of the forecasting module and the policy management module are embodied in computer-executable instructions encoded on computer-readable media.

29. A system as recited in claim 21 wherein the forecasting module forecasts availability periodically.

30. A system as recited in claim 21 wherein the forecasting module forecasts the availability in response to receiving the request.

31. A system as recited in claim 21 wherein the policy management module selects an initial policy prior to receipt of the request and selects a revised policy after receipt of the request based on the forecasted availability.

32. A system as recited in claim 21 wherein the forecasting module forecasts availability based on one or more of current time, current location, or availability of another resource that affects availability of the one or more resources required to handle the request.

33. A system as recited in claim 21 wherein the forecasting module associates the request with the one or more resources.

34. A system comprising:
an application program generating a request to perform an operation requiring one or more resources having variable availability;
means for adapting usage of the one or more resources based on forecasted availability of the one or more resources.

35. A system as recited in claim 34 wherein the means for adapting comprises:
a forecasting module forecasting availability of the one or more resources at a selected time;
a policy management module generating a resource-related policy characterizing the usage of the one or more resources based on the forecasted availability.

36. A system as recited in claim 35 wherein the forecasting module includes forecasting data that relates time to availability of the one or more resources.

37. A system as recited in claim 36 wherein the forecasting data is generated during a learning process.

38. A system as recited in claim 34 further comprising an independent data source generating data that is deterministic of the availability of the one or more resources.
